(19) United States
(12) Patent Application Publication
(10) Pub. No.: US 2023/0042761 A1
(43) Pub. Date: Feb. 9, 2023

(54) Spring mechanism for a seating device

(71) Applicant: Inventor Group GmbH, Wollerau (CH)

(72) Inventor: Thomas Walser, Kreuzlingen (CH)

(73) Assignee: Inventor Group GmbH, Wollerau (CH)

(21) Appl. No.: 17/790,248

(22) PCT Filed: Dec. 30, 2020
(86) PCT No.: PCT/IB20/62528

§ 371 Date: Jun. 30, 2022

Related U.S. Application Data
(60) Provisional application No. 62/955,329, filed on Dec. 30, 2019.

(51) Int. Cl. A47C 3/025; A47C 3/026; A47C 7/00

(52) U.S. Cl. CPC A47C 3/0255; A47C 3/026; A47C 7/006

(57) ABSTRACT

A spring mechanism for a chair or a stool includes a base mount connected to a base and a seat mount connected to a seat. Two swing arms are arranged above one another. The two swing arms include a lower swing arm and an upper swing arm. Each of the two swing arms is pivotally connected to the seat mount and pivotally connected to the base mount. A spring is provided and arranged to generate an upwardly directed force onto the seat.

### CROSS-REFERENCE TO RELATED APPLICATION

This application is a national phase entry of international patent application PCT/IB2020/062528, filed 2020 Dec. 30, and claims priority to U.S. Provisional Patent Application No. 62/955,329, filed 2019 Dec. 30, the contents of which are hereby incorporated by reference.

### TECHNICAL FIELD

The present application relates to a spring mechanism for a seating device.

### BACKGROUND

Mechanisms that allow axial and possibly lateral movement of a seat have traditionally been complex and require many different parts. Such mechanisms are prone to friction, which can cause noise when the seat moves. Known mechanisms were relatively expensive due to their complexity.

Height-adjustable chairs can cause noise when adjusting the height, which is acceptable because the adjustment is temporary. With vertically swinging seat devices, the vertical movement is practically permanent while sitting. Noise-free operation is therefore very important.

### SUMMARY

A spring mechanism for a seating device, e.g., a chair or a stool, includes a base mount connected to a base and a seat mount connected to a seat. Two swing arms are arranged above one another. The two swing arms include a lower swing arm and an upper swing arm. Each of the two swing arms is pivotally connected to the seat mount and pivotally connected to the base mount. A spring is arranged to generate an upwardly directed force onto the seat.

The lower swing arm may be pivotally connected to the seat mount by a lower seat bearing. The upper swing arm may be pivotally connected to the seat mount by an upper seat bearing. The lower swing arm may be pivotally connected to the base mount by a lower base bearing, and the upper swing arm may be pivotally connected to the base mount by an upper base bearing. The lower seat bearing and the upper seat bearing may be arranged in a first plane, which may be vertical. The lower base bearing and the upper base bearing may be arranged in a second plane, which may also be vertical.

The lower swing arm may include a left lower swing arm member and a right lower swing arm member. The upper swing arm may include a left upper swing arm member and a right upper swing arm member. The left lower swing arm member and the left upper swing arm member may be arranged directly above one another. Similarly, the right lower swing arm member and the right upper swing arm member may be arranged directly above one another. Alternatively, the left lower swing arm member and the left upper swing arm member may be arranged at a left lateral offset from one another, and the right lower swing arm member and the right upper swing arm member may be arranged at a right lateral offset from one another.

The spring may be a compression spring. A lower end of the compression spring may be supported on the base, and an upper end of the compression spring may be connected to and supported on the lower swing arm or the upper swing arm. Alternatively, the spring may be a tension spring. A first end of the tension spring may be operatively connected to the base, for example to the base mount. A second end of the tension spring may be operatively connected to the seat, for example to the seat mount.

If the spring is a tension spring, a first end of the tension spring may be supported on the base above the upper base bearing, and a second end of the tension spring may be supported on the seat below the lower seat bearing.

An adjustment mechanism may be used by which a vertical position of the first end of the tension spring can be adjusted relative to the base or a vertical position of the second end of the tension spring can be adjusted relative to the seat.

The upper swing arm or the lower swing arm may be arcuately shaped. The lower swing arm or the upper swing arm may be integrally formed as a housing of the spring mechanism.

The upper swing arm and the lower swing arm may touch one another when the seat is in an uppermost position or when the seat is in a lowermost position.

The upper swing arm or the lower swing arm may be generally U-shaped.

The spring may generate a spring force having a horizontal component and a vertical component. A ratio of the vertical component to the horizontal component may increase when the seat is downwardly depressed.

The lower seat bearing may be arranged vertically above the lower base bearing when the seat is in an uppermost position. The lower seat bearing may be vertically arranged below the lower base bearing when the seat is in a lowermost position.

The seat mount may be laterally offset from a center of the seat. The base mount may be laterally offset from a center of the base.

A distance between the upper base bearing and the upper seat bearing and a distance between the lower base bearing and the lower seat bearing may be different. A distance between the lower base bearing and the upper base bearing and a distance between the lower seat bearing and the upper seat bearing may be different.

The upper swing arm or the lower swing arm may include an inner lever portion between its seat bearing and its base bearing and an outer lever portion which extends outwardly beyond its seat bearing or its base bearing. In combination with a tension spring, one end of the tension spring may then be supported by a spring retainer bar which is accommodated on the outer lever portion. The spring mechanism may include a plurality of further tension springs arranged adjacent to the tension spring.

### BRIEF DESCRIPTION OF THE DRAWINGS

FIG. 1A shows a stool with a spring-biased seating surface partially loaded in an intermediate position.

FIG. 1B shows the stool as in FIG. 1A unloaded in an upper position.

FIG. 1C shows the stool as in FIG. 1A fully loaded in a lower position.

FIG. 2A shows a base and a spring mechanism for a stool or a chair in an upper position.

FIG. 2B shows the base and the spring mechanism as in FIG. 2A in an intermediate position.

FIG. 3A is a side view of the configuration as in FIG. 1A.

FIG. 3B is a side view of the configuration as in FIG. 1B.

FIG. 3C is a side view of the configuration as in FIG. 1C.

FIG. 4 is a perspective view of an alternative base with a spring mechanism.

FIG. 5 is a side view of the base and spring mechanism as in FIG. 4.

FIG. 6A is a side view of an alternative spring mechanism for use with a chair or a stool in an upper position.

FIG. 6B is a side view of the mechanism as in FIG. 6A in an intermediate position.

FIG. 6C is a side view of the mechanism as in FIG. 6A in a lower position.

FIG. 7 is a side view of a base and a spring mechanism, illustrating the lateral movement of a column which supports the seat of a chair in different spring displacement positions.

FIG. 8 is a perspective view of a stool with a spring mechanism

FIG. 9 is a perspective view of an office chair with a spring mechanism.

FIG. 10 is a side view of an office chair with a base-mounted spring mechanism.

FIG. 11 is a side view of an office chair with a seat-mounted spring mechanism.

FIG. 12 is a perspective view of an office chair with an alternative base-mounted spring mechanism.

FIG. 13A is a side view of an office chair with a seat-mounted alternative spring mechanism in a fully loaded configuration.

FIG. 13B is a side view as in FIG. 13A in an unloaded configuration.

FIG. 14A is a detailed view of a spring mechanism under load configured for minimum pre-tension.

FIG. 14B is a detailed view of the spring mechanism as in FIG. 14A without load configured for minimum pre-tension.

FIG. 14C is a detailed view of the spring mechanism as in FIG. 14A under load configured for maximum pre-tension.

FIG. 14D is a detailed view of the spring mechanism as in FIG. 14A without load configured for maximum pre-tension.

FIG. 15A is a schematic showing a first configuration of a spring mechanism under load.

FIG. 15B is a schematic showing the configuration as in FIG. 15A without load.

FIG. 16A is a schematic showing a second configuration of a spring mechanism under load.

FIG. 16B is a schematic showing the second configuration as in FIG. 16A without load.

FIG. 17A is a side view of an office chair with a base-mounted alternative spring mechanism in an unloaded configuration.

FIG. 17B is a side view as in FIG. 17A in a fully loaded configuration.

### DETAILED DESCRIPTION

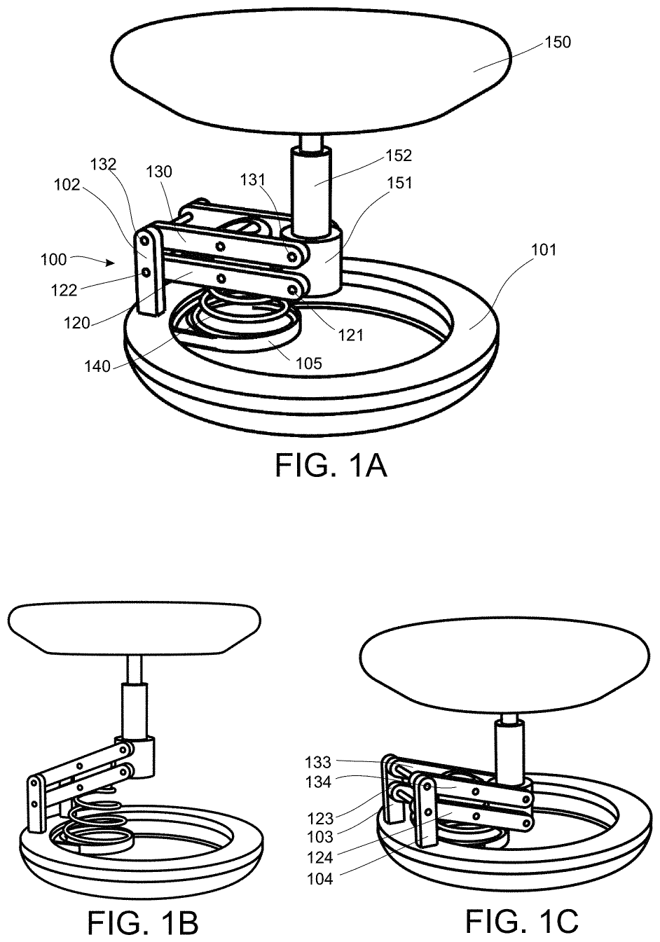

Referring to FIGS. 1A, 1B and 1C and FIGS. 3A, 3B and 3C, a stool is shown in three different configurations. FIGS. 1A and 3A shows the stool in a use configuration when a weight is placed onto the seat 150. FIGS. 1B and 3B shows the stool in an unloaded configuration when no weight is placed onto the seat 150. As shown in FIGS. 1B and 3B, the seat 150 is in its uppermost position. FIGS. 1C and 3C shows the stool in a fully loaded configuration when a large weight is placed onto the seat 150. As shown in FIGS. 1C and 3C, the seat 150 is in its lowermost position.

The stool comprises a seat 150 and a base 101. Generally, this application refers to seating devices as a chair if the seating device includes a backrest and as a stool if the seating device does not include a backrest. The stool includes a spring mechanism 100 which exerts an upwardly directed biasing force onto the seat 150.

The spring mechanism 100 includes a base mount 102 that is firmly connected to the base 101 and a seat mount 151 that is firmly connected to the seat 150. An elongated seat column 152 extends downwardly from the seat 150. An upper end of the seat column 152 is firmly connected to the seat 150. A lower end of the seat column 152 is firmly connected to the seat mount 151 of the spring mechanism 100.

The spring mechanism 100 includes two swing arms 120, 130 that are arranged above one another. The two swing arms include a lower swing arm 120 and an upper swing arm 130. Each of the two swing arms 120, 130 is pivotally connected to the seat mount 151 at a first end and pivotally connected to the base mount at a second end. A spring 140 is arranged to generate an upwardly directed force onto the seat mount 151.

More specifically, the lower swing arm 120 is pivotally connected to the seat mount 151 by a lower seat bearing 121, and to the base mount 102 by a lower base bearing 122. Analogously, the upper swing arm 130 is pivotally connected to the seat mount 151 by an upper seat bearing 131, and to the base mount 102 by an upper base bearing 132.

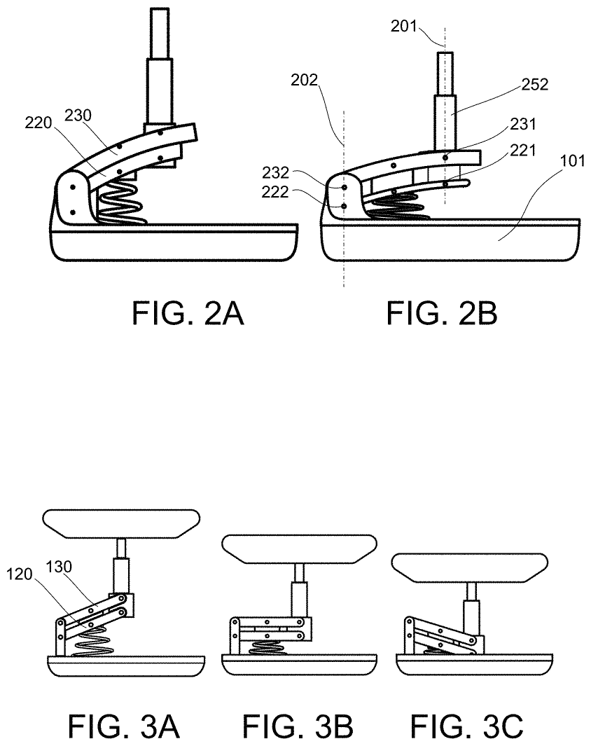

As illustrated in FIG. 2B, the lower seat bearing 221 and the upper seat bearing 231 are arranged in a first vertical plane 201. In the illustrated example, the seat column 252 is also arranged in the first vertical plane, as is a center of the seat. On an opposite side of the spring mechanism 100, the lower base bearing 222 and the upper base bearing 232 are arranged in a second vertical plane 202. The first vertical plane 201 and the second vertical plane 202 are arranged at a lateral offset from one another. The first vertical plane 201 is generally centrally arranged relative to the base 101 whereas the second vertical plane 202 is arranged at an outer portion of the base 101.

Referring back to FIGS. 1A-1C, the lower swing arm 120 includes a left lower swing arm member 123 and a right lower swing arm member 124. The upper swing arm 130 includes a left upper swing arm member 133 and a right upper swing arm member 134. The left lower swing arm member 123 and the right lower swing arm member 124 are arranged in parallel and spaced apart from one another. The left upper swing arm member 133 and the right upper swing arm member 134 are also arranged in parallel and spaced apart from one another.

The left upper swing arm member 133 and the right upper swing arm member 134 are attached on opposite sides to the seat mount 151. The upper seat bearing 131 may include an upper seat bearing rod that extends from the left upper swing arm member 133 through the seat mount 151 to the right upper swing arm member 134. The same configuration applies to the left lower swing arm member 123 and the right lower swing arm member 124. The lower seat bearing 121 may include a lower seat bearing rod that extends from the left lower swing arm member 123 through the seat mount 151 to the right lower swing arm member 124.

The base mount 102 may include a left base mount member 103 and a right base mount member 104. Each of the left and right base mount member may be an elongated structure that extends generally vertically from the base 101. The upper left swing arm member 133 and the lower left swing arm member 123 are pivotally arranged proximal to the left base mount member 103. The upper right swing arm member 134 and the lower right swing arm member 124 are pivotally arranged proximal to the right base mount member 104. In particular, the upper left swing arm member 133 and upper right swing arm member 134 may be pivotally supported by an upper base bearing rod that extends through the left base mount member 103 and the right base mount member 104. The lower left swing arm member 123 and lower right swing arm member 124 may be pivotally supported by a lower base bearing rod that extends through the left base mount member 103 and the right base mount member 104.

Preferably, the swing arm members are arranged inside the base mount members. That is, a distance between the left and right swing arm member is preferably shorter than a distance between the left and right base mount members. However, the arrangement can be reversed with the swing arm members being attached to an outer side of the base mount 102.

The left lower swing arm member 123 and the left upper swing arm member 133 may be arranged directly above one another. The same applies to the right lower swing arm member 124 and the right upper swing arm member 134 which may be arranged directly above one another. However, in some configurations it may be preferred to arrange the upper and lower swing arm members at an offset from one another. In particular the left lower swing arm member 123 and the left upper swing arm member 133 may be arranged at a left lateral offset from one another, and the right lower swing arm member 124 and the right upper swing arm member 134 may be arranged at a right lateral offset from one another.

The spring 140 may be a compression spring. More specifically, the spring 140 may be a conical compression spring to support a wide range of weights to be placed onto the seat 150. A lower end of the compression spring 140 is supported on the base 101. An upper end of the compression spring is connected to the lower swing arm 120 or the upper swing arm 130. The upper end of the compression spring 140 may be supported by a spring rod which extends through the left upper swing arm member 133 and the right upper swing arm member 134. The spring rod may alternatively extend through the left lower swing arm member 123 and the right lower swing arm member 124.

As shown in FIGS. 2A and 2B, the upper swing arm 230 and the lower swing arm 220 may be arcuately shaped, in particular arched, i.e. be upwardly curved. Each swing arm 220, 230 may comprise separate left and right swing arm members or may be an integrally formed element. The swing arm 220, 230 may in particular be a generally U-shaped element in which a rounded portion of the U-shaped element wraps around the seat mount 151. Open legs of the U-shaped element may then be pivotally connected to the base mount 102.

As shown in FIG. 2A, the lower swing arm 220 and the upper swing arm may abut when the seat is in an uppermost position. This abutment may form an upper stop for the spring mechanism 100. The lower swing arm 220 and the upper swing arm may also abut when the seat is in a lowermost position and thereby form a lower stop for the spring mechanism 100.

As shown in FIGS. 3A, 3B and 3C, the lower swing arm 120 and the upper swing arm 130 may be arranged to always be parallel to one another. In this configuration, the upper seat bearing and the lower seat bearing are always directly above one another. So are the upper base bearing and the lower base bearing. The lower swing arm 120 and the upper swing arm 130 are geometrically part of a parallelogram.

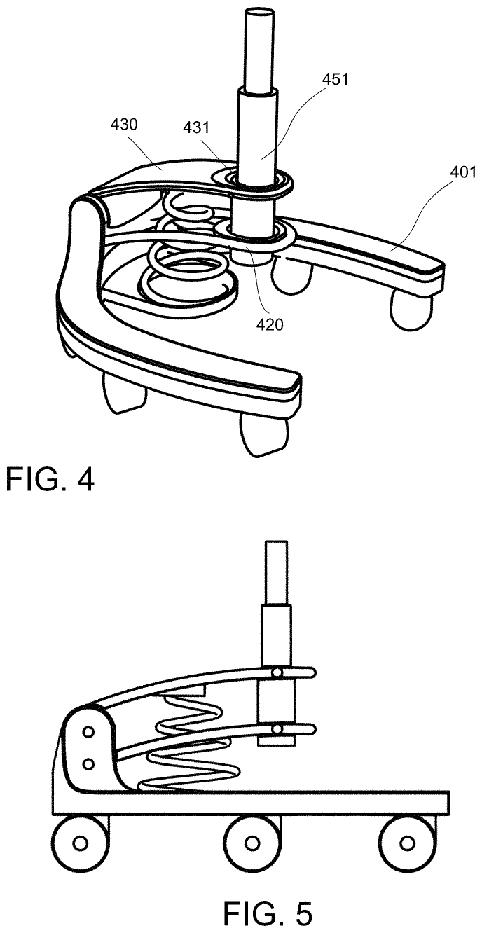

FIGS. 4 and 5 shows that the upper swing arm 430 and the lower swing arm 420 need not be identical parts. As illustrated, the upper swing arm 430 is an integrally formed element which includes an aperture 431 through which the seat mount 451 extends and in which the seat mount 451 is pivotally supported. In contrast, the lower swing arm 420 is a generally U-shaped element which wraps around and pivotally supports a lower portion of the seat mount 451. The base 401 is horse-shoe shaped and supported on caster wheels.

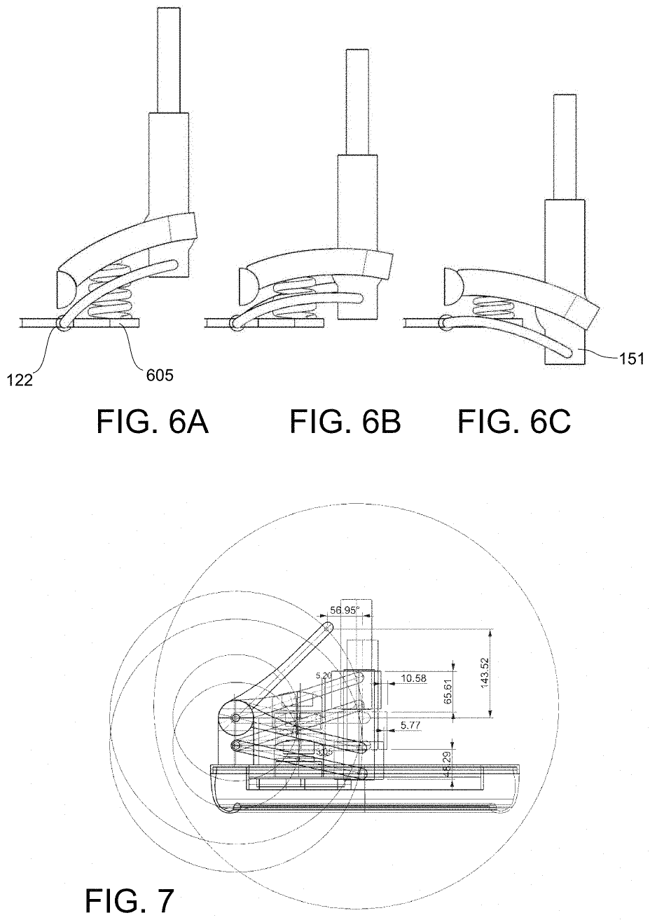

As shown in FIGS. 6A-6C, the lower end of the compression spring 140 may be supported on a spring support plate 605. The spring support plate 605 extends from the base mount 102 towards the seat mount. The spring support plate 605 is firmly connected to the base. The spring support plate 605 does not limit downward travel of the seat mount 151. As shown in FIG. 6C, in a lowermost position a lower end of the seat mount 151 may reach below the spring support plate 605. As shown, the lower base bearing 122 may be arranged in a common horizontal plane with the spring support plate 605.

FIG. 7 shows exemplary dimensions and proportions of a spring mechanism 100.

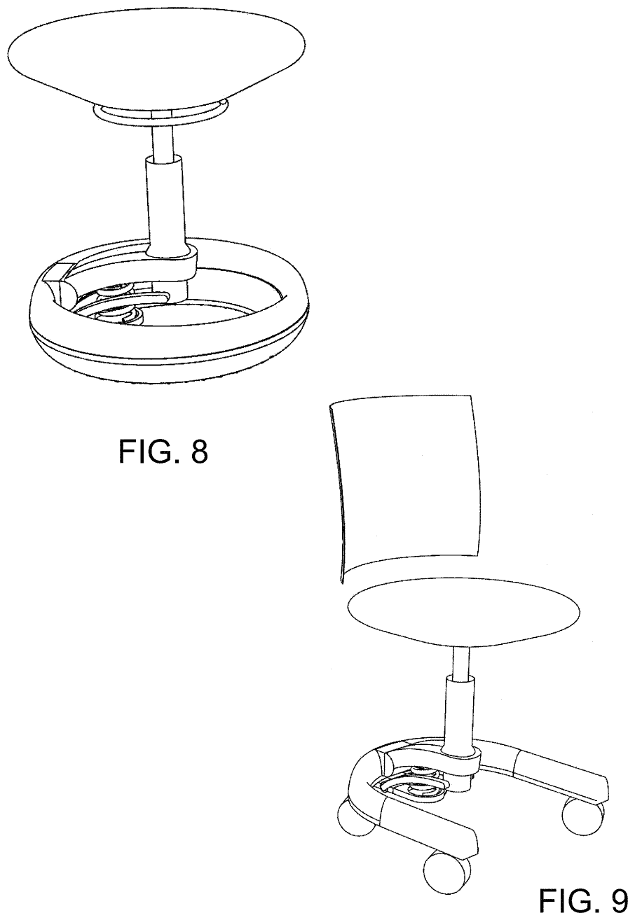

FIG. 8 shows an exemplary embodiment of a stool with a spring mechanism as described on a round base. FIG. 9 shows an exemplary embodiment of a chair with a spring mechanism as described. The chair uses a generally U-shaped base with an open end of the U-shaped base facing the front of the chair.

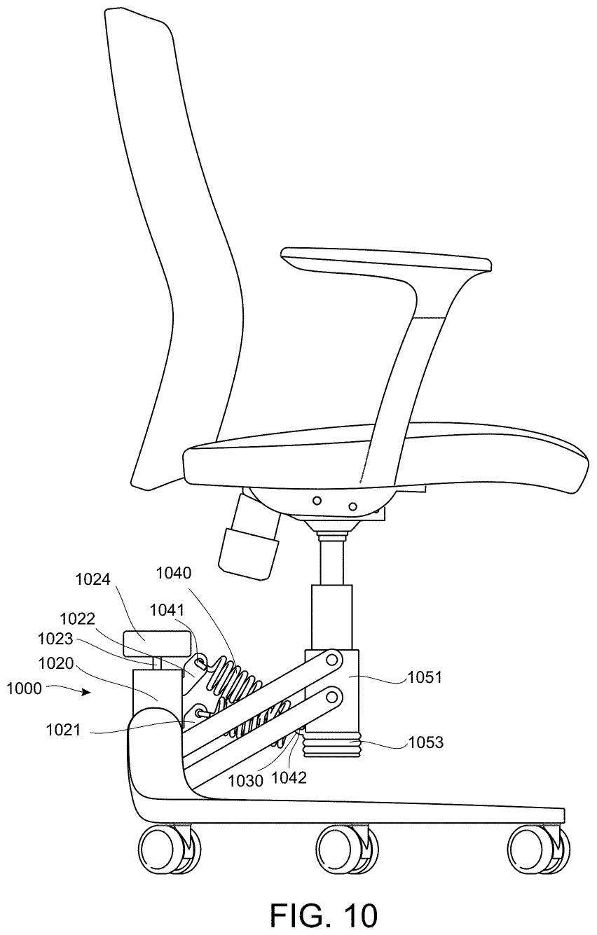

FIG. 10 shows a differently configured spring mechanism 1000. Instead of a compression spring, the spring mechanism 1000 uses a tension spring 1040. A first end 1041 of the tension spring is held on a base spring support 1020. A second end 1042 of the spring is held on a seat spring support 1030. The base spring support 1020 is height-adjustable. FIG. 10 shows the height-adjustable base spring support superimposed in a lower position 1021 and in an upper position 1022. Height adjustment of the base spring support 1020 is affected by turning an adjustment knob 1024 which is connected to a threaded spindle 1023. An outer thread of the threaded spindle 1023 engages an inner thread of the base spring support 1020. The base spring support is held in and guided by the base mount.

An elastic stopper 1053 is arranged at a lower end of the seat mount 1051. The elastic stopper 1053 provides a safety feature in case the chair is overloaded relative to the pre-load of the tension spring 1040. In that case, the elastic stopper 1053 may hit the base or the floor when the seat is occupied, but due to its elasticity prevent damage and injury.

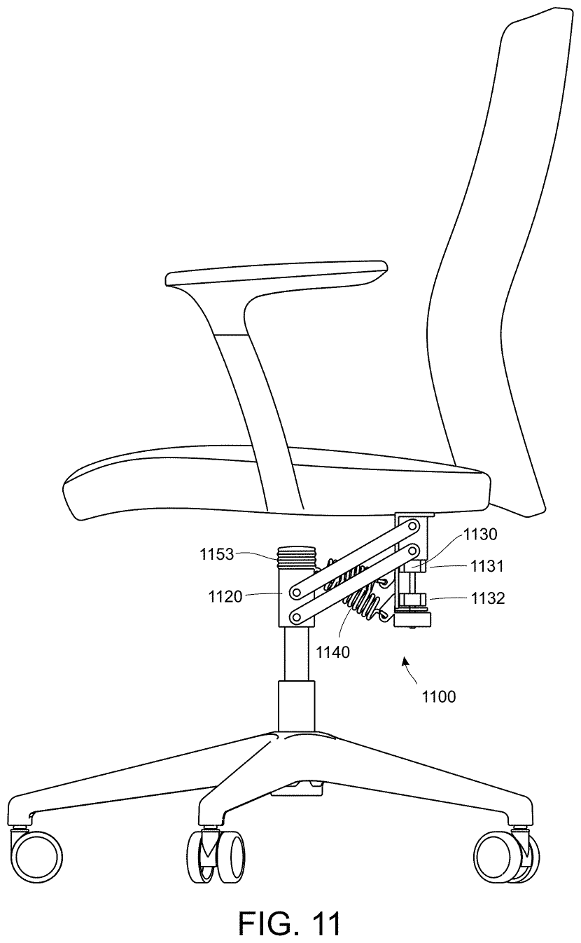

FIG. 11 shows a configuration in which the spring mechanism 1100 is mounted directly under the seat of a chair rather than on the base. The seat-mounted spring mechanism 1100 mirrors the design of the base-mounted spring mechanism 1000 shown in FIG. 10. Here, it is the seat spring support 1130 that is adjustable and shown superimposed in both an upper position 1131 and a lower position 1132.

The spring adjustment mechanism allows the tension spring 1140 to be pre-tensioned and the upwardly directed force on the seat to be adjusted. The adjustment mechanism utilizes two effects. First, a length of the tension spring 1140 extends as the seat spring support 1030 moves from its upper position 1131 to its lower position 1132. This alone increases a pre-tension force exerted by the tension spring 1140. Secondly, the direction of force exerted by the tension spring 1140 changes as the seat spring support 1030 moves downwardly, and a vertical component of the force increases. When the chair is unloaded and the spring 1140 is minimally pre-tensioned with the seat spring support 1130 being in the upper position 1131, the spring has an upward angle from the horizontal of approximately 10 degrees. The upward force acting on the seat is then F_{Seat}=F_{Spring_relaxed}×sin(10°)=F_{Spring_relaxed}×0.17. When the chair is unloaded and the spring 1140 is maximally pre-tensioned with the seat spring support 1130 being in the lower position 1132, the spring has an upward angle from the horizontal of approximately 32 degrees. The upward force acting on the seat is then F_{Seat}=F_{Spring_pretensioned}×sin (32°)=F_{Spring_pretensioned}×0.53.

The orientational change of the spring 1140 towards a more vertical orientation increases when the chair is loaded. In that case, the seat mount moves downwardly relative to the base mount. The spring is thereby further extended, and the component of the spring force which provides an upwardly directed force onto the seat increases. The orientational change of the spring effectively amplifies the vertical force exerted onto the seat as it moves downwardly, thereby enabling a steep force-travel curve that allows users of vastly different weights to use the chair. Worded differently, a ratio of the vertical component to the horizontal component of the spring force increases when the seat is downwardly depressed.

An elastic stopper 1153 is arranged at an upper end of the base mount 1120. The elastic stopper 1153 provides a safety feature in case the chair is overloaded relative to the pre-load of the tension spring 1140. In that case, the seat may hit the elastic stopper 1153, but due to the elasticity of the stopper 1153 damage and injury are prevented.

As illustrated in FIG. 10 and FIG. 11, the tension spring 1040, 1140 may be arranged between the seat mount and the base mount. In particular, the tension spring 1040, 1140 may be centrally arranged between respective left and right arm members. As shown, the upper and lower seat bearings are in that case arranged at one end of the respective arms. The upper and lower base bearings are arranged at an opposite second end of the respective arms.

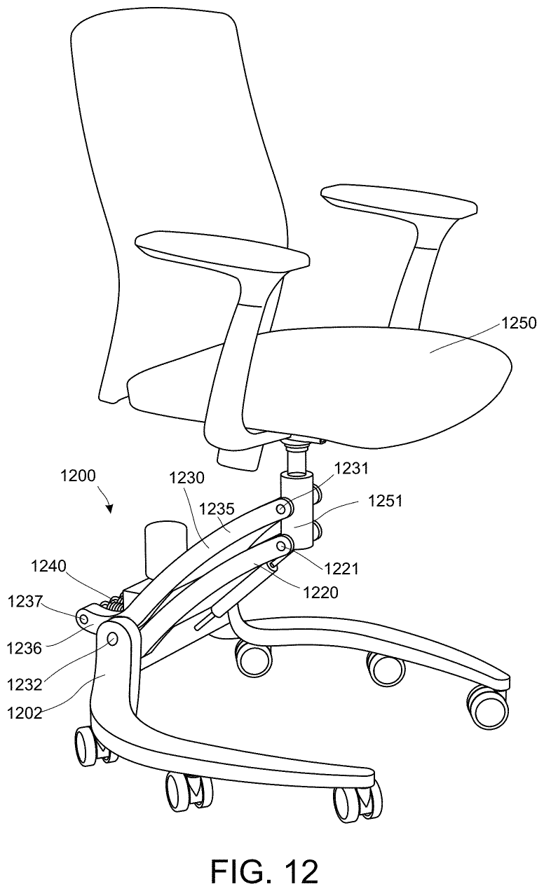

A differently configured spring mechanism is shown in FIG. 12. The spring mechanism 1200 includes an upper arm 1230 and a lower arm 1220. Both the upper arm 1230 and the lower arm 1220 are pivotally connected to a seat mount 1251. An upper seat bearing 1231 and a lower seat bearing 1221 are arranged at respective first ends of the upper arm 1230 and the lower arm 1220.

The upper arm 1230 and the lower arm 1220 are also pivotally connected to a base mount 1202. The upper base bearing 1232 is shown. The lower arm 1220 is connected to the base mount 1202 by a lower base bearing (not shown) which is arranged directly below the upper base bearing 1232.

In this configuration, the upper arm 1230 extends outwardly beyond the upper base bearing 1232. The upper arm 1230 effectively forms a lever having an inner lever portion 1235 and an outer lever portion 1236. A spring retaining bar 1237 is arranged at a second end of the upper arm 1230, opposite the first end at which the upper arm 1230 is connected to the seat mount 1251. A plurality of tension springs 1240 are supported on the spring retaining bar 1237 and exert a partially downwardly directed force onto the second end of the upper arm 1230. This partially downwardly directed force on the outer lever portion 1236 translates into an upwardly directed force onto the seat 1250.

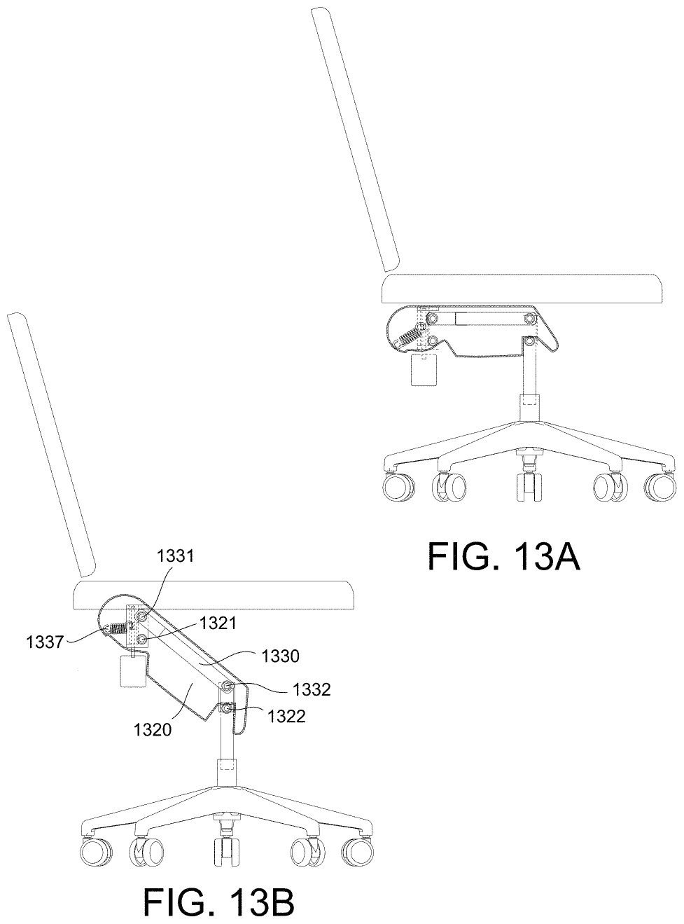

A lever-based spring mechanism can generally be mounted at the base, as shown in FIG. 12. It can also be mounted under the seat, as shown in FIG. 13A and FIG. 13B. As shown in FIG. 13A and FIG. 13B, the upper arm 1330 is formed as an elongated rod, whereas the lower arm is integrally formed as part of a housing 1320. The housing 1320 is pivotally connected to the base mount by a lower base bearing 1322 and pivotally connected to the seat mount by a lower seat bearing 1321. The housing 1320 also includes a spring retaining bar 1337 to which a plurality of tensions spring are attached. The housing 1320 so meets all of the kinematic requirements to function as a lower arm. The housing 1320 additionally covers the spring mechanism 1300 from view and inadvertent access. The housing also provides inherent torsional rigidity that prevents the seat from moving sideways.

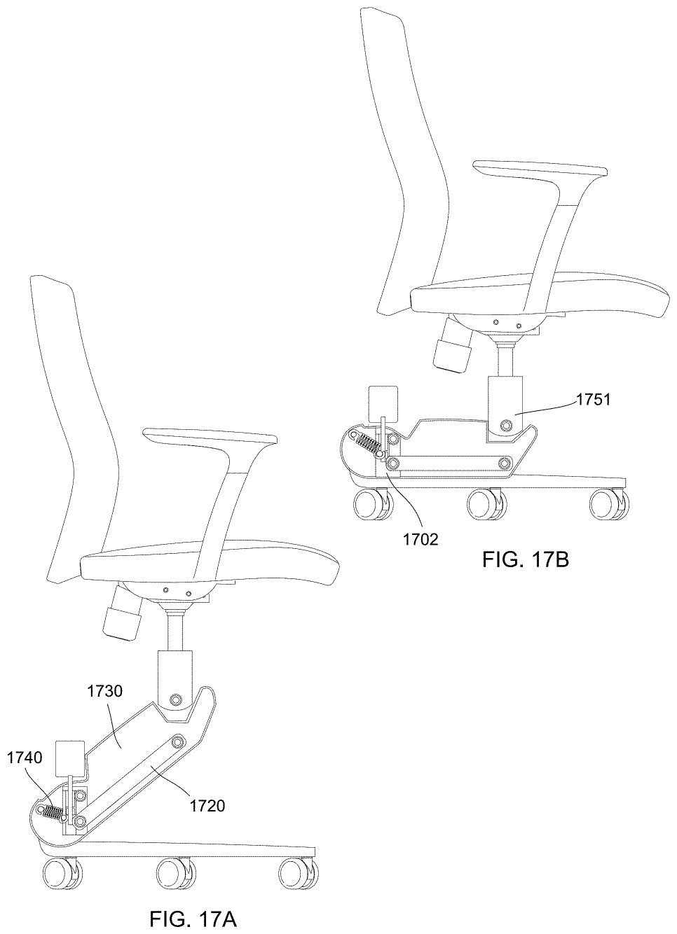

FIG. 17A and FIG. 17B show an application of the lever-based spring mechanism mounted at the base of a chair. This embodiment utilizes a housing 1730 to form an upper swing arm. The housing 1730 completely encapsulates the lower swing arm 1720, and the spring 1740. The housing 1730 at least partially encapsulates the base mount 1702 and the seat mount 1751.

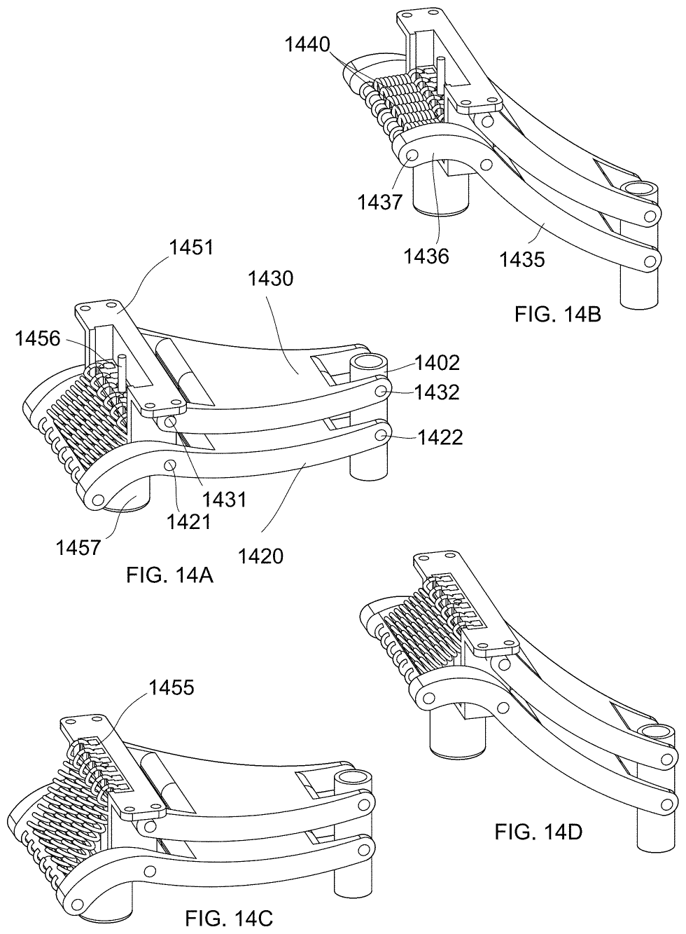

FIGS. 14A-D show an exemplary configuration of a lever-based spring mechanism in more detail. As shown in FIGS. 12, 13A and 13B, the lever-based spring mechanism can be mounted either under the seat or at the base. The mechanism may be applied beyond the use in home or office seating devices and may be applied, for example, to vehicle seating. For example, the spring mechanism may be used in motorcycles or bicycles to connect a saddle to a frame. The spring mechanism may also be used in seating applications for trucks, construction equipment, farm equipment and the like. Various further uses can be envisioned. For that reason, the terms “seat mount” and “base mount” may more generally be referred to as “first mount” and “second mount.” All other elements may mutatis mutandis be referred to by generic “first” and “second” terms as well.

The spring mechanism 1400 includes a seat mount 1451 and a base mount 1402. An upper arm 1430 is pivotally connected to the base mount 1402 by an upper base bearing 1432 and pivotally connected to the seat mount 1451 by an upper seat bearing 1431. A lower arm 1420 is pivotally connected to the base mount 1402 by a lower base bearing 1422 and pivotally connected to the seat mount 1451 by a lower seat bearing 1421.

The lower arm 1420 has an inner lever portion 1435 which extends between the lower base bearing 1422 and the lower seat bearing 1421. An outer lever portion 1436 extends on an opposite side of the seat bearing 1421 and includes a spring retaining bar 1437. A plurality of tensions springs 1440 extend between the spring retaining bar 1437 and the seat mount 1451.

The seat mount 1451 includes an adjustment mechanism to pre-tension the tensions springs 1440. For that purpose, a spring support 1455 is slidingly arranged and guided by the seat mount 1451. The spring support 1455 holds inner ends of the tension springs 1440, the outer ends of which are held by the spring retaining bar 1437 of the lower arm 1420. The spring support 1455 can move vertically within the seat mount 1451. The vertical position of the spring support is adjustable by rotating a threaded spindle 1456. The threaded spindle 1456 extends into and is firmly connected to an adjustment knob 1457.

As shown and described before, the tension springs 1440 are arranged such that they extend and assume a more vertical orientation when the chair is loaded or when the pre-tensioning of the chair is tightened. The increasingly vertical orientation of the tensions springs 1440 increases a vertical component of the spring force, which supports the seat vertically.

The lower arm 1420 and the upper arm 1430 are torsionally stiff components having a width greater than their heights. This torsional stiffness prevents the seat from moving sideways. The lower arm and the upper arm have a generally trapezoidal shape and extend outwardly around the base mount and the seat mount to further support their torsional stiffness.

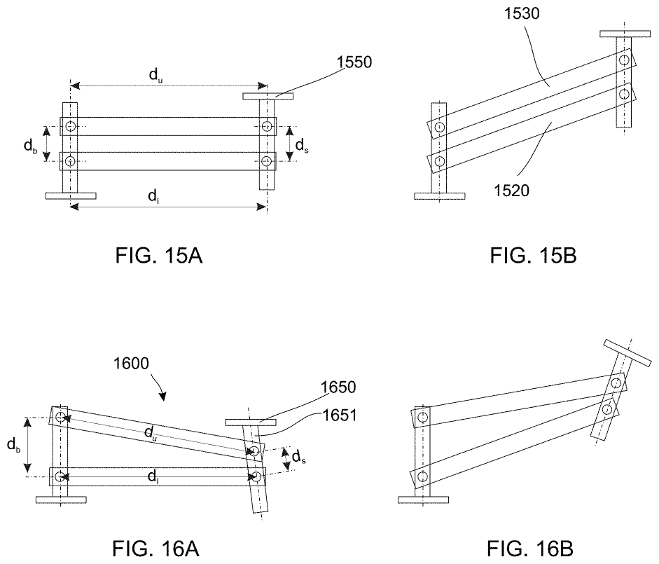

Referring now to FIGS. 15A and 15B, a symmetrical configuration is shown in which the upper arm 1530 and the lower arm 1520 are always parallel to one another. In this “parallelogram-configuration,” the upper and lower seat bearings are spaced apart from one another by the same distance dₛ, as the upper and lower base bearings, which are spaced apart by a distance d_{b}. The upper seat bearing and upper base bearing are spaced apart, along the upper arm, by the same distance dᵤ as the lower seat bearing from the lower base bearing along the lower arm. This symmetrical arrangement allows the seat 1550 to maintain a horizontal orientation, irrespective of its vertical position. The distances are defined by the extension perpendicular to the center axes of the respective bearings.

For some applications it may be desirable to pivot the seat forward when in its upper position. This allows a user to more easily sit down, especially for chairs and stools that have a relatively high upper position. This includes for example seating devices in which the seat assumes an unoccupied upper position of more than 75 cm from the ground.

Kinematically, this can be achieved by an asymmetrical spring mechanism 1600 as schematically shown in FIG. 16A and FIG. 16B. In this configuration, the upper and lower arms as in FIG. 15A are used. The distance dᵤ between the upper seat bearing and the upper base bearing and the distance di between the lower seat bearing and the lower base bearing are identical. However, the distance d_{b} between the upper base bearing and the lower base bearing is greater than the distance dₛ between the upper seat bearing and the lower seat bearing. The seat 1650 is mounted to the seat mount 1651 at an angle, such that in a use-position as shown in FIG. 16A the seat 1650 is approximately horizontally oriented. In the unloaded upper position as shown in FIG. 16B, the seat 1650 is now notably pivoted forward. A forwardly pivoted upper position of a seat is also shown in FIG. 13B.

While the present invention has been described with reference to exemplary embodiments, it will be readily apparent to those skilled in the art that the invention is not limited to the disclosed or illustrated embodiments but, on the contrary, is intended to cover numerous other modifications, substitutions, variations and broad equivalent arrangements that are included within the spirit and scope of the following claims.

The various features presented in this specification and shown in the drawings are not mutually exclusive and can be freely combined. For example, the use of a tension spring does not preclude that the spring mechanism at the same time includes a compression spring even if a combination of tension and compression spring is not specifically shown.

The words “example” and “exemplary” as used herein mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

1. An office chair or stool, comprising:
a base (101);
at least four caster wheels supporting the base (101);
a seat (150)
a base mount (102) connected to the base (101);
a seat mount (151) connected to the seat (150);
two swing arms arranged above one another, the two swing arms including
a lower swing arm (120) and
an upper swing arm (130),
each of the two swing arms (120, 130) being pivotally connected to the seat mount (151) and pivotally connected to the base mount (102); and
a spring (140) arranged to generate an upwardly directed force onto the seat.

2. The office chair or stool as in claim 1,
wherein the lower swing arm (120) is pivotally connected to the seat mount (151) by a lower seat bearing (121), and
wherein the upper swing arm (130) is pivotally connected to the seat mount (151) by an upper seat bearing (131), and
wherein the lower swing arm (120) is pivotally connected to the base mount (102) by a lower base bearing (122), and
wherein the upper swing arm (130) is pivotally connected to the base mount (102) by an upper base bearing (132).

3. The office chair or stool as in claim 2,
wherein the lower seat bearing (121) and the upper seat bearing (131) are arranged in a first vertical plane (201), and
wherein the lower base bearing (122) and the upper base bearing (132) are arranged in a second vertical plane (202).

4. The office chair or stool as in claim 1,
wherein the lower swing arm (120) comprises a left lower swing arm member (123) and a right lower swing arm member (124), and
wherein the upper swing arm (130) comprises a left upper swing arm member (133) and a right upper swing arm member (134).

5. The office chair or stool as in claim 4,
wherein the left lower swing arm member (123) and the left upper swing arm member (133) are arranged directly above one another, and
wherein the right lower swing arm member (124) and the right upper swing arm member (134) are arranged directly above one another.

6. The office chair or stool as in claim 4,
wherein the left lower swing arm member (123) and the left upper swing arm member (133) are arranged at a left lateral offset from one another, and
wherein the right lower swing arm member (124) and the right upper swing arm member (134) are arranged at a right lateral offset from one another.

7. The office chair or stool as in claim 1,
wherein the spring (140) is a compression spring,
wherein a lower end of the compression spring is supported on the base (101), and wherein an upper end of the compression spring is connected to the lower swing arm (120) or the upper swing arm (130).

8. The office chair or stool as in claim 1,
wherein the spring (140) is a tension spring,
wherein a first end of the tension spring is supported on the base mount (102), and
wherein a second end of the tension spring is supported on the seat mount (151).

9. The office chair or stool as in claim 2,
wherein the spring (140) is a tension spring,
wherein a first end of the tension spring is supported on the base above the upper base bearing (132), and
wherein a second end of the tension spring is supported on the seat below the lower seat bearing (121).

10. The office chair or stool as in claim 1,
wherein the spring (140) is a tension spring having a first end operatively connected to the base and a second end operatively connected to the seat,
further comprising an adjustment mechanism by which a vertical position of the first end relative to the base or a vertical position of the second end relative to the seat can be adjusted.

11. The office chair or stool as in claim 1,
wherein the upper swing arm (130) or the lower swing arm (120) is arcuately shaped.

12. The office chair or stool as in claim 1,
wherein the upper swing arm (130) and the lower swing arm (120) touch one another when the seat is in an uppermost position or when the seat is in a lowermost position.

13. The office chair or stool as in claim 1,
wherein the upper swing arm (130) or the lower swing arm (120) is generally U-shaped.

14. The office chair or stool as in claim 1,
wherein the spring (140) generates a spring force having a horizontal component and a vertical component, and
wherein a ratio of the vertical component to the horizontal component increases when the seat is downwardly depressed.

15. The office chair or stool as in claim 2,
wherein the lower seat bearing (121) is vertically above the lower base bearing (122) when the seat is in an uppermost position.

16. The office chair or stool as in claim 2 or 15,
wherein the lower seat bearing (121) is vertically below the lower base bearing (122) when the seat is in a lowermost position.

17. The office chair or stool as in claim 1,
wherein the seat mount (151) is laterally offset from a center of the seat.

18. The office chair or stool as in claim 1,
wherein the base mount (102) is laterally offset from a center of the base.

19. The office chair or stool as in claim 1,
wherein the lower swing arm is integrally formed as a housing which encloses the upper swing arm, or
wherein the upper swing arm is integrally formed as a housing which encloses the lower swing arm.

20. The office chair or stool as in claim 2,
wherein a distance (du) between the upper base bearing and the upper seat bearing and a distance (dl) between the lower base bearing and the lower seat bearing are different,
or wherein a distance (db) between the lower base bearing and the upper base bearing and a distance (ds) between the lower seat bearing and the upper seat bearing are different.

21.-25. (canceled)

26. The office chair or stool as in claim 1,
wherein the base is horseshoe-shaped.

27. The office chair or stool as in claim 19,
wherein the spring is arranged in the housing.
